(19) United States
(12) Patent Application Publication
(10) Pub. No.: US 2019/0235163 A1
(43) Pub. Date: Aug. 1, 2019

(54) OPTICAL WAVEGUIDE AND METHOD OF MANUFACTURING THE SAME

(71) Applicant: HRL LABORATORIES, LLC, Malibu, CA (US)

(72) Inventors: Pamela R. Patterson, Los Angeles, CA (US); Raymond Sarkissian, Los Angeles, CA (US); Biqin Huang, Torrance, CA (US); Keyvan R. Sayyah, Santa Monica, CA (US); Oleg M. Efimov, Thousand Oaks, CA (US)

(21) Appl. No.: 16/185,855

(22) Filed: Nov. 9, 2018

Related U.S. Application Data
(60) Provisional application No. 62/622,633, filed on Jan. 26, 2018.

(51) Int. Cl. G02B 6/122; G02F 1/025; G02B 6/136

(52) U.S. Cl. CPC G02B 6/122; G02B 2006/12061; G02B 6/136; G02F 1/025

(57) ABSTRACT

A method of manufacturing an optical waveguide includes: aligning a silicon on insulator wafer and a target substrate, the target substrate including a benzocyclobutene layer; bonding a silicon layer of the silicon on insulator wafer with the benzocyclobutene layer of the target substrate by using heat and pressure; and removing the silicon on insulator wafer such that the silicon layer remains on the benzocyclobutene layer.

### CROSS-REFERENCE TO RELATED APPLICATION(S)

The present application claims priority to and the benefit of U.S. Provisional Patent Application Ser. No. 62/622,633, filed on Jan. 26, 2018, the entire content of which is incorporated herein by reference.

### FIELD

One or more aspects of embodiments of the present disclosure relate to an optical waveguide and a method of manufacturing the same.

### BACKGROUND

Generally, a waveguide is a structure that guides waves, such as electromagnetic waves and/or sound waves, with reduced (or minimal) energy loss. An optical waveguide is a waveguide that is configured (or designed) to guide electromagnetic waves in the optical spectrum, including ultraviolet (UV), visible, and infrared (IR) light. Optical waveguides generally include a dielectric material with high permittivity, such as silicon, surrounded by a material having lower permittivity. The dielectric material with high permittivity has a high index of refraction, thereby providing reduced (or minimal) energy loss by the transmitted light. Optical waveguides may operate on the principle of total internal reflection.

In integrated optics, an edge coupler, such as a spot size converter (SSC), is often employed to couple a planar waveguide, such as the above-mentioned optical waveguide, with an optical fiber or a chip-on-butt coupled laser. To realize an efficient, low-loss coupling, the refractive indices of the various materials used in the spot size converter (SSC) and the optical waveguide must be considered, and currently used materials have been found to provide inefficient coupling and/or are not compatible with (or are not easily compatible with) conventional integrated circuit fabrication techniques and processes.

### SUMMARY

Aspects of embodiments of the present disclosure are directed toward an optical waveguide and a method of manufacturing the same. The optical waveguide may be a mid-infrared (mid-IR) optical waveguide including a single crystal silicon layer on a benzocyclobutene (BCB) layer. The method of manufacturing the optical waveguide includes transferring a silicon layer from a silicon on insulator (SOI) wafer onto a target substrate including a BCB layer by using heat and pressure. After the silicon layer from the SOI wafer is bonded to the BCB layer of the target substrate, the SOI substrate is removed, leaving the silicon layer on the BCB layer. Then, an optical waveguide (e.g., an optical waveguide pattern) may be formed in the silicon layer with the BCB layer as a bottom cladding, and a spot size converter may be formed on the optical waveguide to provide efficient, low-loss coupling between the optical waveguide and an optical fiber or the like. In some embodiments, the spot size converter may be formed by lithography (e.g., photolithography), in which a photosensitive material is applied and exposed, such that the optical waveguide is protected (e.g., masked) during subsequent etching of the transferred silicon layer on the BCB layer.

According to an embodiment of the present disclosure, a method of manufacturing an optical waveguide includes: aligning a silicon on insulator (SOI) wafer and a target substrate, the SOI wafer including a silicon carrier and a silicon layer on the silicon carrier, the target substrate including a benzocyclobutene layer; bonding the silicon layer of the SOI wafer with the benzocyclobutene layer of the target substrate by using heat and pressure; and removing the silicon carrier such that the silicon layer remains on the benzocyclobutene layer.

The benzocyclobutene layer may be formed by spin coating.

The silicon layer may be about 2 microns thick.

The method may further include forming an optical waveguide in the silicon layer on the benzocyclobutene layer.

The method may further include forming a spot size converter on the optical waveguide.

The spot size converter may include silicon oxy-nitride.

The method may further include forming a plurality of the optical waveguides in the silicon layer on the benzocyclobutene layer, and the optical waveguides may be parallel with each other.

The method may further include forming a plurality of the optical waveguides in the silicon layer on the benzocyclobutene layer, and the optical waveguides may be curved in different directions from each other.

The target substrate may include an integrated circuit under the benzocyclobutene layer.

According to another embodiment of the present disclosure, a method of manufacturing an optical waveguide includes: forming a benzocyclobutene layer on a silicon substrate by spin coating; bonding the benzocyclobutene layer to a first layer of a wafer, the first layer including silicon or germanium; removing the wafer such that the first layer remains on the benzocyclobutene layer and on the silicon substrate; and forming an optical waveguide in the first layer on the benzocyclobutene layer.

The first layer may be about 2 microns thick.

The method may further include forming a spot size converter on the optical waveguide.

The spot size converter may include silicon oxy-nitride.

According to another embodiment of the present disclosure, an optical waveguide includes: a silicon substrate; a benzocyclobutene layer on the silicon substrate; and an optical waveguide on the benzocyclobutene layer.

The optical waveguide may include silicon.

The optical waveguide may further include a spot size converter on the optical waveguide.

The spot size converter may include silicon oxy-nitride.

The optical waveguide may be directly on the benzocyclobutene layer.

The optical waveguide may include germanium.

The optical waveguide may be directly on the benzocyclobutene layer.

### BRIEF DESCRIPTION OF THE DRAWINGS

These and other aspects and features of the present disclosure will be further appreciated and better understood with reference to the specification, claims, and appended drawings, in which:

FIG. 1 is a perspective view of an optical waveguide according to an embodiment;

FIG. 2 is a perspective view of the optical waveguide shown in FIG. 1 including an edge coupling spot size converter;

FIGS. 3A and 3B are schematic illustrations of optical waveguides according to embodiments;

FIGS. 4A-4D illustrate acts of manufacturing an optical waveguide according to an embodiment;

FIG. 5 is a flow chart describing a method of manufacturing the optical waveguide according to FIGS. 4A-4D; and

FIG. 6 is a graph showing transmission loss of light through an optical waveguide according to an embodiment.

### DETAILED DESCRIPTION

The detailed description set forth below, in connection with the appended drawings, is intended as a description of example embodiments of the present disclosure and is not intended to represent the only forms in which the present disclosure may be embodied. The description sets forth aspects and features of the present disclosure in connection with the illustrated example embodiments. It is to be understood, however, that the same or equivalent aspects and features may be accomplished by different embodiments, and such other embodiments are encompassed within the spirit and scope of the present disclosure. As noted elsewhere herein, like reference numerals in the description and the drawings are intended to indicate like elements. Further, descriptions of features, configurations, and/or other aspects within each embodiment should typically be considered as available for other similar features, configurations, and/or aspects in other embodiments.

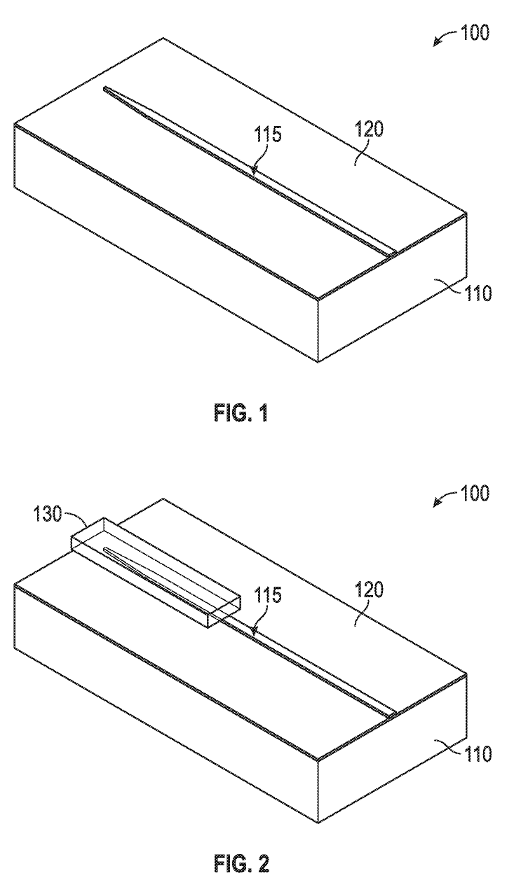

Referring to FIG. 1, an optical waveguide 100 includes a substrate 110, a bottom cladding 120 on the substrate 110, and a waveguide 115 on the bottom cladding 120. The substrate 110 may include (or may be formed of) silicon (Si), and although the present disclosure is not limited thereto, the substrate 110 will be referred to hereinafter as a silicon substrate 110. The silicon substrate 110 may be a bulk silicon substrate. The bottom cladding 120 may include (or may be formed of) benzocyclobutene (BCB), and although the present disclosure is not limited thereto, the bottom cladding 120 will be referred to hereinafter as a benzocyclobutene (BCB) layer 120. The waveguide 115 may include (or may be formed of) silicon (Si) or germanium (Ge), and although the present disclosure is not limited thereto, the waveguide 115 will be referred to hereinafter as the silicon waveguide 115. The silicon waveguide 115 may be a single crystal silicon layer and may be about 2 microns thick. Based on the thickness of the silicon waveguide 115, the optical waveguide 100 is configured for use within the mid-infrared (mid-IR) wavelength (e.g., is optimized for use in the mid-IR wavelength). The mid-IR wavelength region is generally from about 3 microns to about 8 microns, and more specifically, greater than about 4 microns. The thickness of the silicon waveguide 115 may be adjusted for use with different wavelengths as would be understood by those skilled in the relevant art.

Referring to FIG. 2, the optical waveguide 100 includes (e.g., is configured for use with) a spot size converter (SSC) 130. The SSC 130 may be a silicon oxy-nitride (SiON) spot size converter 130 for edge coupling an optical fiber or the like to the silicon waveguide 115. The SSC 130 provides low-loss coupling with fiber optics and low-loss integration with chip-on-butt coupled lasers.

To ensure low-loss coupling between the silicon waveguide 115 and the external element, such as the optical fiber or the chip-on-butt laser, the refractive index of the SSC 130 should be greater than the bottom cladding 120 and less than the waveguide 115. By using silicon or germanium for the waveguide 115, which respectively have refractive indices of about 3.35 and about 4, BCB for the bottom cladding 120, which has a refractive index of about 1.5, and SiON for the SSC 130, which has a tunable refractive index but is generally in a range of about 1.65 to about 1.7 in embodiments of the present disclosure, the above-described relationship between refractive indices is met or substantially met throughout the mid-IR wavelength range. Thus, by using BCB for the bottom cladding 120, a SiON SSC 130 may be used with a silicon or germanium waveguide 115 with relatively low loss in signal strength or power.

In an example according to the related art, a mid-IR waveguide has been demonstrated by using a germanium on silicon structure without the BCB layer therebetween. To satisfy the above-described relationship between refractive indices to provide low-loss coupling, the refractive index of the SSC would need to be between 4 and 3.35 because germanium has a refractive index of about 4 and silicon has a refractive index of about 3.35. However, a SSC having a refractive index between 4 and 3.35 is not currently feasible, rendering the germanium on silicon waveguide undesired due to its relatively poor loss characteristics when used with existing SSCs.

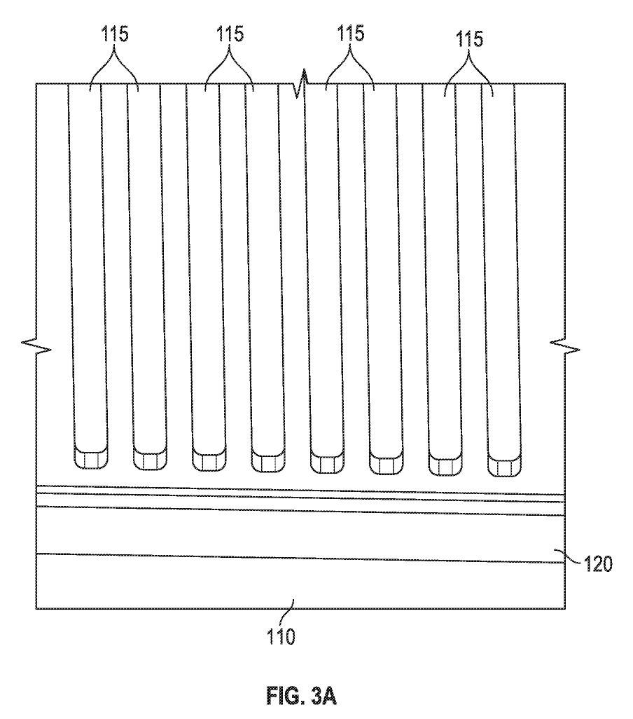

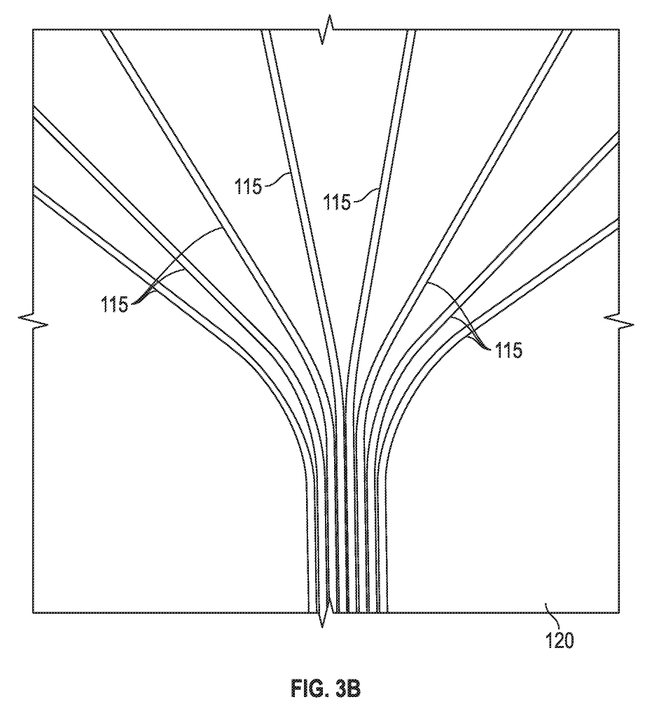

Although FIGS. 1 and 2 show the optical waveguide 100 as only including a single silicon waveguide 115, this is merely for ease of description and the present disclosure is not limited thereto. Other embodiments of an optical waveguide according to embodiments are shown in FIGS. 3A and 3B. FIGS. 3A and 3B show a plurality of silicon waveguides 115 formed on the BCB layer 120. In FIGS. 3A and 3B, the silicon waveguides 115 are ridge waveguides, but the present disclosure is not limited thereto. As will be further described below, the silicon waveguides 115 may be formed by lithographic patterning as is known by those skilled in the relevant art. Further, the silicon on BCB structure described herein is not limited to optical waveguides but may also form the basis for other photonic components, such as ring resonators, phase shifters, couplers, gratings, etc.

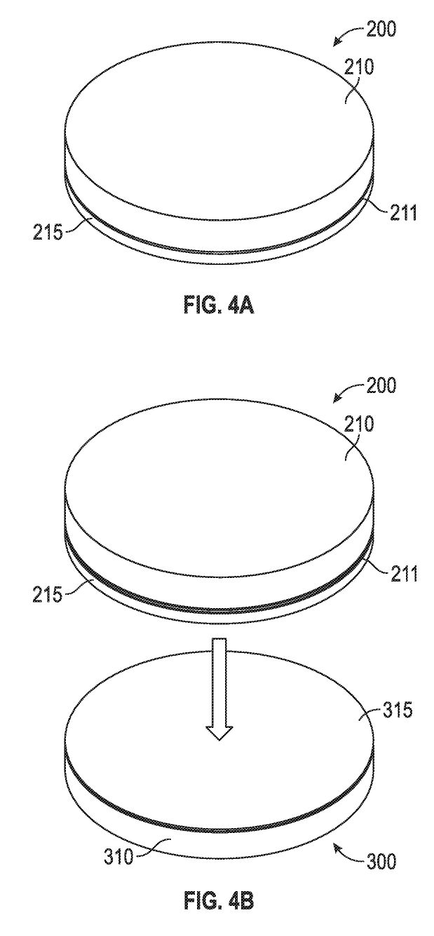

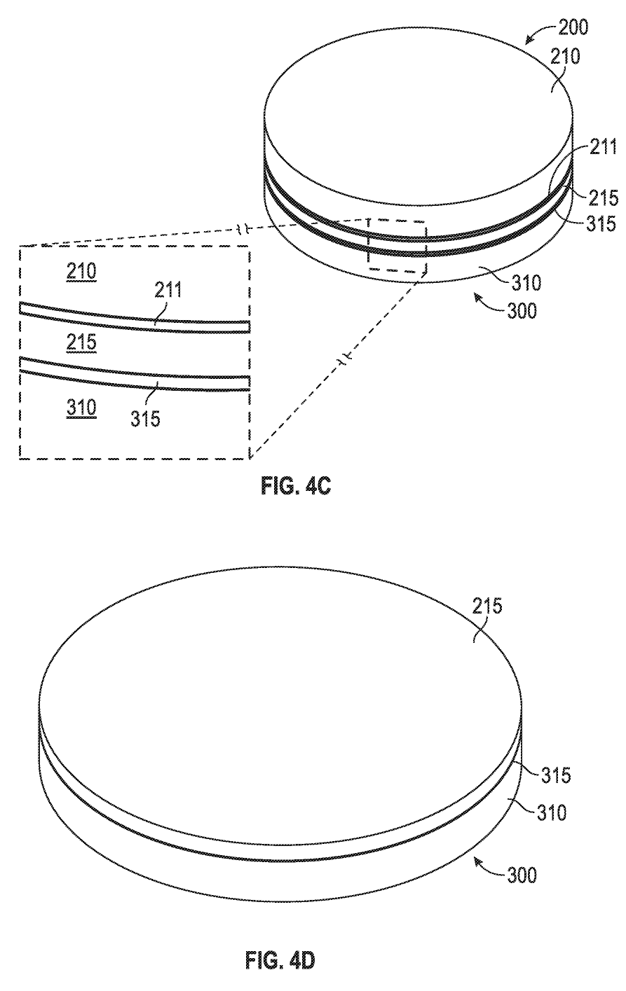

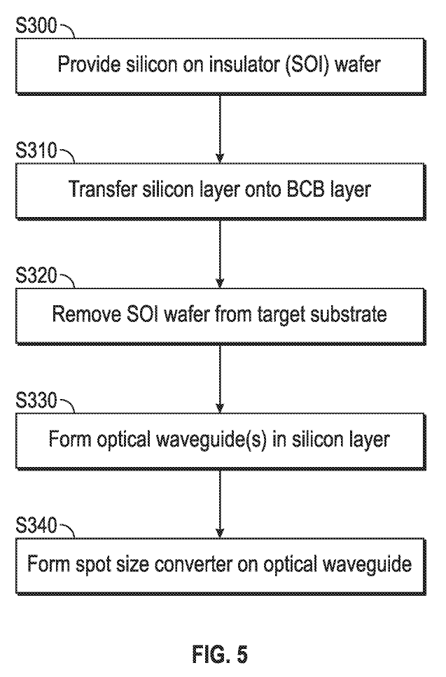

Referring to FIGS. 4A-5, a method of manufacturing an optical waveguide according to an embodiment will be described.

Referring to FIG. 4A, a silicon on insulator (SOI) wafer 200 including a silicon carrier 210, a silicon layer 215, and an insulating layer (e.g., a buried insulating layer) 211 between the silicon layer 215 and the silicon carrier 210 is provided (act S300 in FIG. 5). The SOI wafer 200 may be provided on (or provided as) a bulk silicon substrate. The insulating layer 211 may be a silicon dioxide (SiO₂) layer. In some embodiments, the insulating layer 211 may be omitted. The silicon layer 215 may have any suitable thickness based on the desired characteristics of the optical waveguide to be manufactured. For example, the silicon layer 215 may be about 2 microns thick for use as a mid-IR waveguide, but the thickness of the silicon layer 215 may be variously, suitably modified for different applications. Further, as discussed above, a germanium layer may be used in place of the silicon layer 215, and in other embodiments, a germanium on insulator (GOI) wafer may be used in place of the SOI wafer 200 and may be on a bulk silicon substrate.

Referring to FIG. 4B, a target substrate 300 is provided and includes a substrate 310 and a BCB layer 315 on the substrate 310. The target substrate 300 may be a three inch (e.g., a three-inch diameter) silicon substrate, but the present disclosure is not limited thereto. The target substrate 300 and the SOI wafer 200 may have the same size (e.g., the same diameter), but the present disclosure is not limited thereto. The substrate 310 may be a silicon substrate and may include previously-formed elements, such as processed CMOS or compound semiconductor integrated circuits and the like, but the substrate 310 is not limited thereto and may be any suitable substrate. The BCB layer 315 may be formed on the substrate 310 by using a spin coating method. By spin coating the BCB layer 315 on the substrate 310, a substantially uniform thickness of the BCB layer 315 is ensured.

Referring to FIGS. 4B and 4C, the SOI wafer 200 is bonded to the target substrate 300, and the silicon layer 215 of the SOI wafer 200 is transferred onto (e.g., is adhered to) the BCB layer 315 of the target substrate 300 by using heat and pressure (act S310 in FIG. 5). For example, the SOI wafer 200 and the target substrate 300 are arranged such that the silicon layer 215 faces the BCB layer 315, and then the SOI wafer 200 and the target substrate 300 are brought into contact with each other. The silicon layer 215 of the SOI wafer 200 is then transferred onto the BCB layer 315 of the target substrate 300 by using heat and pressure (act S310 in FIG. 5). In some embodiments, a temperature of about 250° C. and a force of about 5000N (for a three inch wafer pair) may be used to transfer (e.g., to adhere) the silicon layer 215 to the BCB layer 315. As one example, a wafer bonder, such as the EVG501 Wafer Bonding System by EV Group, may be used. By using heat and pressure, the silicon layer 215 and the BCB layer 315 may be bonded to (e.g., adhered to) each other.

After the silicon layer 215 is transferred to the BCB layer 315, the SOI wafer 200 (e.g., the silicon carrier 210 and the insulating layer 211) is removed from the target substrate 330 (act S320 in FIG. 5). In some embodiments, the silicon carrier 210 may be removed by etching (e.g., dry or wet etching) by using an etch (e.g., a highly selective etch) that has a relatively high etch rate with silicon and a relatively very low etch rate with the material of the insulating layer 211 (e.g., silicon dioxide (SiO₂)). As one example, deep reactive-ion etching using sulfur hexafluoride (SF₆) may be used. After the silicon carrier 210 is removed (e.g., is etched), the insulating layer 211 is removed. The insulating layer 211 may be removed by, for example, any suitable dry or wet etching process using an etchant (e.g., a highly selective etchant) that has a relatively high etch rate with the insulating layer 211 (e.g., with silicon dioxide (SiO₂)) and has a relatively very low etch rate with silicon (e.g., with the transferred silicon layer 215). As one example, hydrofluoric acid-based wet or vapor etching may be used. Thereafter, the silicon layer 215 remains on the BCB layer 315 and on the substrate 310 as the exposed layer after the silicon carrier 210 and the insulating layer 211 are removed.

Referring to FIG. 4D, the target substrate 300 including the substrate 310, the BCB layer 315, and the silicon layer 215, which are sequentially stacked on each other, is provided after the silicon carrier 210 and the insulating layer 211 are removed from the target substrate 300. Thereafter, photonic circuits, such as one or more optical waveguides 115, may be formed in the silicon layer 215 on the BCB layer 315 by, for example, lithographic patterning (act S330 in FIG. 5). Lithographic patterning generally includes aligning and exposing a photosensitive material through a patterned mask corresponding to the optical waveguides 115. As one example, a timed etch process may be used to pattern the silicon layer 215, thereby forming the optical waveguides 115.

After the optical waveguides 115 are formed, one or more spot size converters 130 may be formed on (e.g., on an end of) the optical waveguides 115 (act S340 in FIG. 5). The spot size converters 130 may include (or may be formed of) silicon oxy-nitride (SiON). However, the present disclosure is not limited thereto, and the spot size converters 130 may include (or may be formed of) any suitable material meeting the above-discussed refractive index relationship with the waveguide material and the BCB. The spot size converters 130 may be formed by applying a thin film (e.g., about a three micron thick SiON film) onto the silicon layer 215 by using plasma enhanced chemical vapor deposition (PECVD). The thin film for forming the spot size converter 130 may be deposited after the optical waveguides 115 are formed (e.g., after the optical waveguides 115 are patterned). After the thin film is deposited, related art lithography equipment and processes may be used to align and expose a photosensitive material through a patterned mask corresponding to the spot size converters 130, which are formed in alignment with corresponding ones of the optical waveguides 115. As one example, a timed etch process may be used such that the thin film (e.g., the SiON thin film) is about two microns in the field and is about three microns under the spot size converter structure, thereby forming a ridge structure.

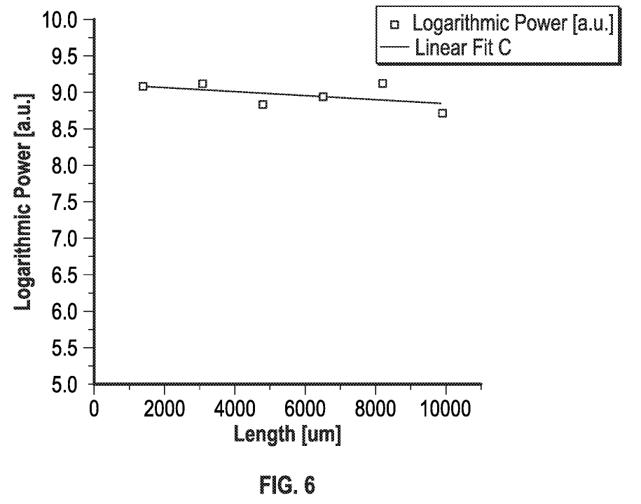

FIG. 6 shows a graph of power loss of light having a 4.5 micron wavelength by distance across an optical waveguide according to an embodiment. As one example, a loss of about 1.2 dB/cm was measured, which is better than other optical waveguides according to the related art that are compatible with CMOS fabrication, such as the above-discussed silicon on germanium structure or a silicon on sapphire structure.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art. As used herein, the term “major component” means a component constituting at least half, by weight, of a composition, and the term “major portion”, when applied to a plurality of items, means at least half of the items.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the terms “exemplary” and “example” are intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although example embodiments of a mid-IR optical waveguide and a method of manufacturing the same have been described and illustrated herein, many modifications and variations within those embodiments will be apparent to those skilled in the art. Accordingly, it is to be understood that a mid-IR optical waveguide and a method of manufacturing the same according to the present disclosure may be embodied in forms other than as described herein without departing from the spirit and scope of the present disclosure. The present disclosure is defined by the following claims and equivalents thereof.

What is claimed is:

1. A method of manufacturing an optical waveguide, the method comprising:
aligning a silicon on insulator (SOI) wafer and a target substrate, the SOI wafer comprising a silicon carrier and a silicon layer on the silicon carrier, the target substrate comprising a benzocyclobutene layer;
bonding the silicon layer of the SOI wafer with the benzocyclobutene layer of the target substrate by using heat and pressure; and
removing the silicon carrier such that the silicon layer remains on the benzocyclobutene layer.

2. The method of claim 1, wherein the benzocyclobutene layer is formed by spin coating.

3. The method of claim 2, wherein the silicon layer is 2 microns thick.

4. The method of claim 2, further comprising forming an optical waveguide in the silicon layer on the benzocyclobutene layer.

5. The method of claim 4, further comprising forming a spot size converter on the optical waveguide.

6. The method of claim 5, wherein the spot size converter comprises silicon oxy-nitride.

7. The method of claim 2, further comprising forming a plurality of the optical waveguides in the silicon layer on the benzocyclobutene layer, the optical waveguides being parallel with each other.

8. The method of claim 2, further comprising forming a plurality of the optical waveguides in the silicon layer on the benzocyclobutene layer, the optical waveguides being curved in different directions from each other.

9. The method of claim 1, wherein the target substrate comprises an integrated circuit under the benzocyclobutene layer.

10. A method of manufacturing an optical waveguide, the method comprising:
forming a benzocyclobutene layer on a silicon substrate by spin coating;
bonding the benzocyclobutene layer to a first layer of a wafer, the first layer comprising silicon or germanium;
removing the wafer such that the first layer remains on the benzocyclobutene layer and on the silicon substrate; and
forming an optical waveguide in the first layer on the benzocyclobutene layer.

11. The method of claim 10, wherein the first layer is about 2 microns thick.

12. The method of claim 10, further comprising forming a spot size converter on the optical waveguide.

13. The method of claim 12, wherein the spot size converter comprises silicon oxy-nitride.

14. An optical waveguide comprising:
a silicon substrate;
a benzocyclobutene layer on the silicon substrate; and
an optical waveguide on the benzocyclobutene layer.

15. The optical waveguide of claim 14, wherein the optical waveguide comprises silicon.

16. The optical waveguide of claim 15, further comprising a spot size converter on the optical waveguide.

17. The optical waveguide of claim 16, wherein the spot size converter comprises silicon oxy-nitride.

18. The optical waveguide of claim 14, wherein the optical waveguide is directly on the benzocyclobutene layer.

19. The optical waveguide of claim 14, wherein the optical waveguide comprises germanium.

20. The optical waveguide of claim 19, wherein the optical waveguide is directly on the benzocyclobutene layer.
